(19) United States
(12) Patent Application Publication
(10) Pub. No.: US 2015/0256225 A1
(43) Pub. Date: Sep. 10, 2015

(54) COMMUNICATION SYSTEM

(71) Applicant: TRYONIC LTD, London Greater London (GB)

(72) Inventor: Fabio Cappelli, London (GB)

(73) Assignee: TRYONIC LTD, London Greater London (GB)

(21) Appl. No.: 14/423,036

(22) PCT Filed: Aug. 16, 2013
(86) PCT No.: PCT/IB2013/056684

§ 371 Date: Feb. 20, 2015

(30) Foreign Application Priority Data
Aug. 21, 2012 (IT) TV2012A000168

(51) Int. Cl. H04B 5/00

(52) U.S. Cl. CPC H04B 5/0037

(57) ABSTRACT

There is described a transmission system of electrons, comprising (i) a transmitter of electrons comprising a first source of a first magnetic or electromagnetic field, and a source of electrons capable of injecting electrons into the first field, and (ii) a receiver of electrons comprising a second source of a second magnetic or electromagnetic field with opposite polarity to the first field, and a receiver of electrons to extract electrons traveling in the second field and coming from the first field. The first and second field have interacting lines of force between each other adapted and in which to make the electrons travel.

The invention relates to a communication and transmission system, to the method and to the means to carry it out.

Modern communication technologies are substantially of two types: wireless and wired. The first type notoriously suffers the problem of creating initially the communication network that must connect all devices. Each device must be informed of the network it belongs to or somehow it must be able to join it. Then problems of reflections, multi-path or channel interference occur. The second type obviously has the disadvantage of requiring a fixed physical transmission medium (the cable). Although bus systems have streamlined the architecture, there remain the problems of physical manual connection.

It is very, and more and more, felt the need to be able to connect quickly several electronic devices to make them talk. Clearly, as discussed above, the traditional systems hinder a lot the speed for network's formation. Then we want to provide a system which improves this state of the art, in particular that allows the rapid formation of the connection network necessary for communication between two or more electronic devices.

Such a system is defined in the appended claims. It is a transmission system of electrons (therefore usable for electrical communication of signals), comprising
a transmitter of electrons comprising
   a first source of a first magnetic or electromagnetic field,
   a source of electrons capable of injecting electrons into the first field, and
a receiver of electrons comprising
   a second source of a second magnetic or electromagnetic field with opposite polarity to the first field,
   a receiver of electrons to extract electrons traveling in the second field and coming from the first field,
wherein the first and second field have field lines interacting with each other adapted to, and in which to, make the electrons travel.

Between the two sources there are established lines of force which guide and convey the electrons from the source to the receiver. The electrons injected close to the first source are transported to the second source, from which they are recovered to re-form the transmitted signal.

Preferably the first and second field are sinusoidally variable and/or generated by sinusoidal excitation. This allows for both simplicity as an embodiment and an excellent control of the field structure. Even other waveforms are possible, as square waves, sawtooth waves, or signals that do not always have a constant cyclicity, because they self-adjust to the response of the system.

Preferably the first and second field oscillate at a certain same frequency, which ensures the “tuning” between the transmitter and the receiver. A device may be provided adapted to drive one or each source to generate a field by frequency scanning or frequency sweeping, in order to search the frequency at which the other source is tuned. At this aim, the first and second field can oscillate, then, with adjustable frequency.

Preferably the transmitter and/or receiver are enclosed in a casing which comprises the material as defined below (i.e. a material that supports and extends the lines of force of the sources inside it to ensure that they are able to cross it). The presence of said casing gives resistance and mechanical support to an object of the system while solving the problem of having to generate fields with limited power.

Preferably the transmitter and/or receiver are separated by or supported on an external body comprising the material as defined below. Still, the material boosts and/or supports the lines of force for the transmitted electrons.

Said material comprises a dispersion of particles capable of generating a magnetic field in the space external to them. Such lines of field become lines of force for the electrons transmitted and in transit.

Preferably substantially all the particles are adapted to generate a magnetic field with polar axis, where the polar axis of substantially all the particles have the same orientation. In this way the geometry of the fields is more ordered and allows the creation of series of “bridge” particles for the lines of field/force.

Preferably the orientation of the magnetic fields is substantially perpendicular to a surface of the material, so as to facilitate the crossing of it for the overall lines of force.

Preferably a plurality of particles is substantially aligned along a direction orthogonal to the surface, in order to create an aligned sequence of particles generating a “channel” of lines of force.

For the same reason, preferably the magnetic field has a polar axis substantially perpendicular to the surface.

Preferably the particles are electrically conductive (e.g. metallic particles) to enable the flow of electrons not only along the lines of force but also, for mere electric conduction, along or through the body of the particles.

Preferably, particles that are permanent magnets or permanently magnetized are used, thanks to which a magnetic field is generated easily.

Preferably said layer is made of plastic material, easy to produce and excellent support for the particles.

Preferably, the layer includes doping particles as beryllium, phosphorus or barium or belonging to the lanthanides (atomic number from 58 to 71) or magnesium or scandium or yttrium, to facilitate the conduction. These particles are magnetizable, and can be used as particles adapted to generate said magnetic field in space.

It is also proposed a method for obtaining a material as above, comprising the steps of
dispersing particles in a layer of material, each particle being provided with a magnetic field external to it with a polar axis,
passing close to the material an orienting magnetic field for orienting the polar axis of substantially all the particles in substantially equal manner.

The advantages of having particles with oriented polar axis in the same direction have already been described before.

In particular in the method the polar axis is oriented substantially perpendicular to a (e.g. major) surface of the layer.

As variants of the method, either alone or in combination:
electrically conductive particles are used;
   the external orienting magnetic field moves substantially tangentially to the surface.

It is also proposed
a device having a housing made of the above-defined material, and
a machine adapted to perform the method defined above, so as to produce plates, parts or components made of such material.

Note that the method can integrate phases to carry out each variant or property described for the material or a layer thereof, or for the communication system. The vice-versa also holds.

Note that the method, the material or a layer thereof, and the communication system share the technical (and physical) feature of the electron transport on a line of force of an electromagnetic field, in order to transmit information between two electronic devices.

The advantages of the invention will be more apparent from the following

description of a preferred embodiment, making reference to the attached drawing in which

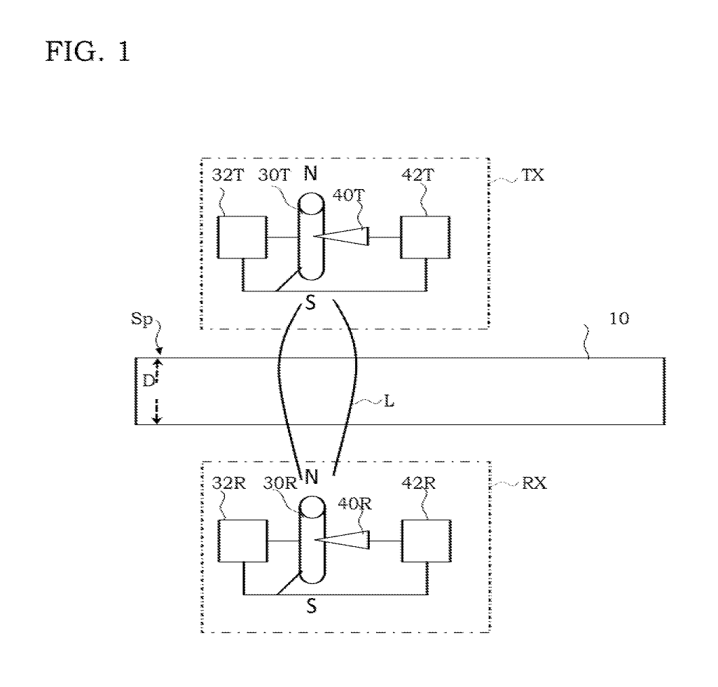

FIG. 1 shows a diagram of a communication system;

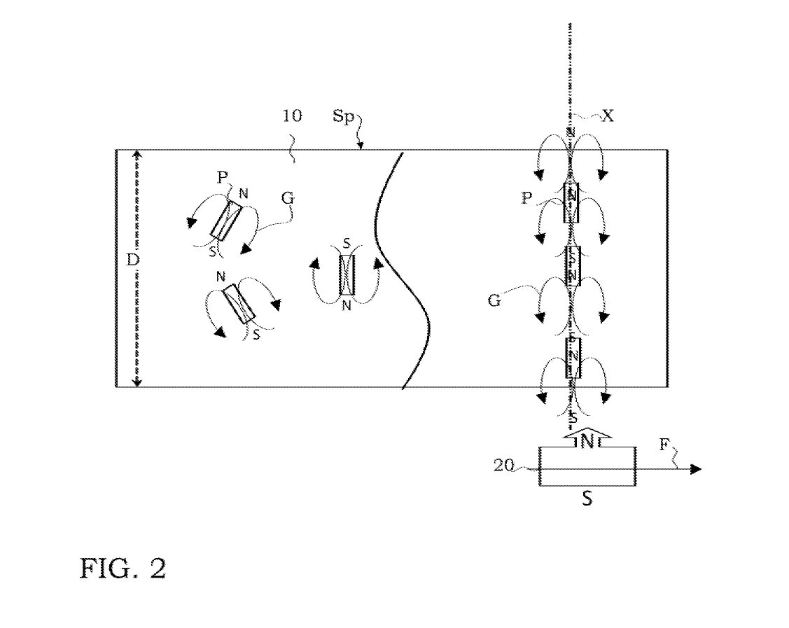

FIG. 2 shows a preparation phase of a material;

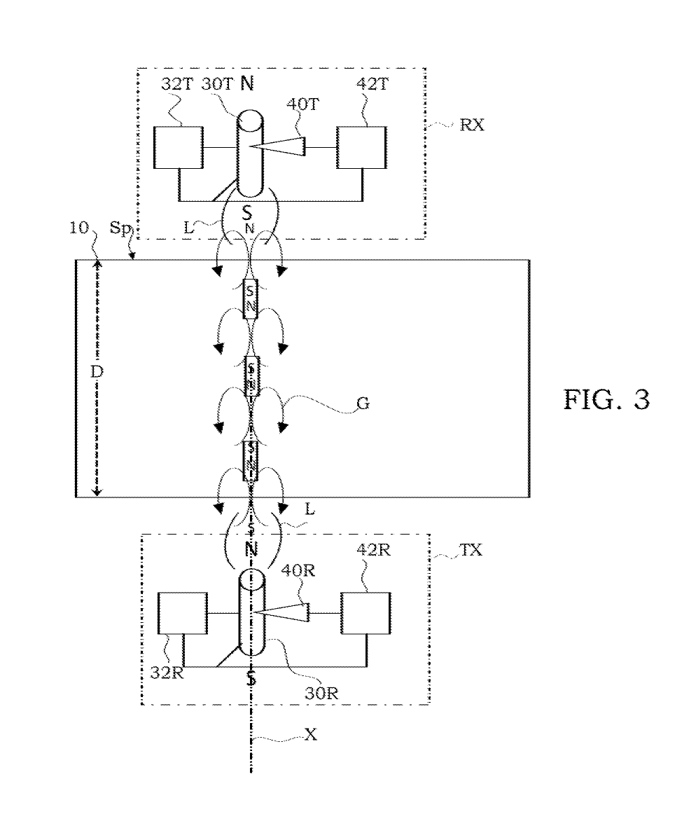

FIG. 3 shows a diagram of a variant of communication system.

In the following, same reference numerals indicate the same components, and unless required they will be described only once.

FIG. 1 shows two electronic devices TX, RX separated by a layer 10 of material having a surface Sp and a thickness D. In this example, the thickness D may tend to zero, to the limit being absent.

The device TX is a transmitter, the device RX a receiver. For the sake of simplicity here and in the following the description will focus on a unidirectional communication, the devices TX, RX being able, however, to possess both functions of transmitter and receiver.

The device TX comprises a source 30T of field of magnetic or electromagnetic force, e.g. a solenoid, driven by a circuit 32T, eg. an oscillating circuit LC.

The source 30T, whose magnetic polarity is shown with abbreviations N, S (north, south), is connected with a source of electrons 40T, e.g. an antenna or typically a source or a means capable of emitting and injecting electrons into the field generated by the source 30T. Preferably the injection point is in correspondence of the external lines of force and/or around the source 30T; in the case of a solenoid not inside it but next to it.

The source 40T is powered and controlled by a circuit 42T that serves to modulate the electronic stream as a function of an information to be transmitted to the receiver RX. E.g. the source 40T can be connected to or modulated by e.g. an audio and/or video signal or data.

The device TX comprises a source 30R of field of magnetic or electromagnetic force, e.g. a solenoid, driven by a circuit 32R, eg. an oscillating circuit LC. The source 30R has magnetic polarity, still indicated with abbreviations N, S (north, south), opposite to that of the source 30T, so that between the two sources 30T, 30R there become established common lines L of magnetic or electromagnetic field (and so correspondingly there are lines of force of its sources 30T, 30R interacting with each other).

The source 30R is connected with an absorber of electrons 40R, e.g. an antenna or generally an extractor or a means capable of extracting or receive electrons from the field generated by the source 30T, 30R.

The absorber is connected to a circuit 42T that serves to process and/or modulate the electronic stream extracted from the field.

### OPERATION

To transmit an electronic stream from the device TX to the one RX, the sources 30T, 30R are activated by the respective circuits 32T, 32R for emitting a magnetic or electromagnetic field to a given frequency. Such a field for an injected electron becomes a field of lines of force (see the lines of force L). Lines of force L are thus formed, generated by the magnetic or electromagnetic field, that pass through the material 10. The circuit 42T drives the source 40T to emit the desired stream of electrons. The electrons from the source 40T jump in the generated force field, stripped by the force (not by the field) generated by the field, and traveling on the lines of force L, by virtue of the Lorentz force (see e.g. the book Electricity and Magnetism by Edward M. Purcell, Berkeley Physics Course). They arrive at the source 30R, where they are taken by the absorber 40R and transferred to the circuit 42R, where they will rebuild the information sent.

The system allows the transmission of infinite channels, separated in frequency (see below). It suffices that the circuit 32T varies the frequency of the field emitted by the source 30T, e.g. by varying the frequency of excitement of a solenoid or coil.

At each frequency generated by the source 30T and 30R corresponds a different path of an electron emitted by the source 40T on the lines of force L (closer to or further from the polar N-S axis of the source 30T).

This because of the well-known formula of Lorentz

F=q*E+q*V×B,

where q is the electron charge, and V the speed (fixed) with which the source 40T emits it.

In the system, the contribution of the electric field E is negligible, thus there remains

F=q*V×B, (A1).

By changing the frequency in the source 30T one varies the frequency of the generated magnetic or electromagnetic field B. An electron injected by the source 40T influences the field B by making its lines of field become lines of force, indicated with L in the figure, on which the electron will travel.

The frequency variation in the source 30T results in a frequency variation of the magnetic or electromagnetic field, which translates, as discussed above, in a variation of the force field.

Given the constancy of the speed V, the formula A1 then expresses the selectivity of the “channel” that can be set in the communication system. E.g. for the n-th channel it will hold

Fₙ=q*V×Bₙ, (A2).

So at a certain n-th excitation frequency of the source 30T the electrons can follow (and travel on) only the corresponding line of force F. There is thus a correspondence, see formula A2, between frequency of excitation or field generation in the source 30T and the line of force that the electrons will go to ride upon.

FIG. 3 shows the case in which the thickness D is not negligible, and the force field with the lines L is not sufficiently intense inside the material 10. In this case the problem is solved by integrating into the material 10 some repeaters of magnetic field (see also FIG. 2).

In the thickness D there are dispersed particles P capable of generating a magnetic field G external to them, still indicated with poles N, S (North, South). A source of magnetic field 20 external to the material 10 is passed (direction F) or approached in the vicinity of the same material 10, so as to orient, physically (mechanical rotation) and/or spatially (the particles P stand still and only the field G moves), the magnetic fields G of substantially all the particles P. The orientation of the fields G takes place so that the polar axis of the lines of field G for all particles P has substantially equal orientation, see. FIG. 2 on the right and axis X. Now every particle P has field lines that interact with a near particle P.

When (see FIG. 3) the transmitter TX wants to send an electronic stream to receiver RX, everything happens as in the previous case.

The only difference is that the lines of force L generated by the sources 30T, 30R now interact on the ends (poles) of the row of particles P. The electrons travelling on the lines L in the material 10 will travel on magnetic field lines (now force lines) G present around the particles P.

The curvature of the lines G allows the jump of the electrons also from particles P which are not aligned or not located along the polar axis. Therefore the devices TX, RX are not required to stay along a line orthogonal to the surface Sp.

Two devices RX and TX offset with respect to the orthogonal “find” themselves thanks to the properties of the lines of force L, which also in space define paths of constant field strength. An analogy can be the motion of a satellite in space when it uses gravity of several planets as it travels. The satellite is in an orbit of a planet which corresponds to a certain gravitational energy, and when it moves away from that planet sooner or later it sufferd the influence of another planet is approaching to. The jump from the first to the second orbit will take place at the point where to the two orbits corresponds equal energy. In the same way an electron can veer in space inside the material 10 from a field G to the other, even in directions having an angle different from 90° with respect to the plane of the surface Sp.

1. Transmission system of electrons, comprising
a transmitter of electrons comprising
a first source of a first magnetic or electromagnetic field,
a source of electrons capable of injecting electrons into the first field,
a receiver of electrons comprising
second source of a second magnetic or electromagnetic field with opposite polarity to the first field,
a receiver of electrons to extract electrons traveling in the second field and coming from the first field,
wherein the first and second field have lines of force interacting with each other adapted, an in which, to make the electrons travel.

2. A system according to claim 1, wherein the first and second field are sinusoidally variable.

3. A system according to claim 1, wherein the first and second field oscillate at an adjustable frequency.

4. A system according to claim 1, wherein the transmitter and/or receiver are enclosed in a casing that comprises the material according to one of the following claims.

5. A system according to claim 1, wherein the transmitter and/or receiver are separated by or supported on an external body comprising the material according to one of the following claims.

6. Layer of material comprising a dispersion of particles adapted to generate a magnetic field in the space outside them.

7. Layer according to claim 6, wherein substantially all particles are adapted to generate a magnetic field with polar axis, where the polar axis of substantially all the particles has the same orientation.

8. Layer according to claim 6, wherein the particles are electrically conductive.

9. Layer according to claim 1, wherein the particles are permanent magnets or permanently magnetized.

10. A method for obtaining a material according to one of preceding claims, comprising the steps of
dispersing within a layer of material particles each provided with an external magnetic field with a polar axis,
passing close to the material an orienting magnetic field to orient the polar axis of substantially all of the particles in a substantially equal direction.
